(19) United States
(12) Patent Application Publication
(10) Pub. No.: US 2025/0112243 A1
(43) Pub. Date: Apr. 3, 2025

(54) NEGATIVE ELECTRODE FOR LITHIUM SECONDARY BATTERY, METHOD FOR MANUFACTURING NEGATIVE ELECTRODE FOR LITHIUM SECONDARY BATTERY, AND LITHIUM SECONDARY BATTERY COMPRISING NEGATIVE ELECTRODE

(71) Applicant: LG ENERGY SOLUTION, LTD., Seoul (KR)

(72) Inventors: Young Jae KIM, Daejeon (KR); Min Ji KIM, Daejeon (KR); Jaewook LEE, Daejeon (KR)

(21) Appl. No.: 18/730,238

(22) PCT Filed: Sep. 6, 2023
(86) PCT No.: PCT/KR2023/013295

§ 371 Date: Jul. 18, 2024

(30) Foreign Application Priority Data
Sep. 7, 2022 (KR) 10-2022-0113647
Sep. 5, 2023 (KR) 10-2023-0117635

(51) Int. Cl. H01M 4/62; H01M 4/02; H01M 4/04; H01M 4/131; H01M 4/1391; H01M 4/36; H01M 4/48; H01M 10/052

(52) U.S. Cl. CPC H01M 4/628; H01M 4/0404; H01M 4/0435; H01M 4/131; H01M 4/1391; H01M 4/366; H01M 4/48; H01M 4/623; H01M 10/052; H01M 2004/027

(57) ABSTRACT

The present disclosure relates to a negative electrode for a lithium secondary battery, a method for manufacturing the negative electrode, and the lithium secondary battery including the negative electrode. The negative electrode can include a negative electrode current collector layer, a silicon-based negative electrode active material layer provided on at least one surface of the negative electrode current collector layer, and a ceramic layer provided on a surface of the silicon-based negative electrode active material layer opposite to a surface of the negative electrode active material layer facing the negative electrode current collector layer. The ceramic layer can include a ceramic layer composition or a dried product thereof, and the ceramic layer composition can include ceramic and a binder. BaTiO₃ can be included in an amount of 10 parts by weight or more and 50 parts by weight or less based on 100 parts by weight of the ceramic.

### CROSS-REFERENCE TO RELATED APPLICATIONS

The present application is a National Phase entry pursuant to 35 U.S.C. § 371 of International Application No. PCT/KR2023/013295, filed on Sep. 6, 2023, and claims priority to and the benefit of Korean Patent Application No. 10-2022-0113647 filed in the Korean Intellectual Property Office on Sep. 7, 2022, and Korean Patent Application No. 10-2023-0117635 filed in the Korean Intellectual Property Office on Sep. 5, 2023, the entire contents of which are incorporated herein by reference for all purposes as if fully set forth herein.

### TECHNICAL FIELD

The present disclosure relates to a negative electrode for a lithium secondary battery, a method for manufacturing the negative electrode for a lithium secondary battery, and the lithium secondary battery including the negative electrode.

### BACKGROUND

Due to the rapid increase in the use of fossil fuels, the demand for the use of alternative energy or clean energy is increasing, and as part thereof, the fields that are being studied most actively are the fields of power generation and power storage using an electrochemical reaction.

At present, a secondary battery is a representative example of an electrochemical device that utilizes such electrochemical energy, and the range of use thereof is gradually expanding.

Along with the technology development and the increase in demand for mobile devices, the demand for secondary batteries as an energy source is sharply increasing. Among such secondary batteries, lithium secondary batteries having high energy density and voltage, long cycle life, and low self-discharging rate have been commercialized and widely used. In addition, research is being actively conducted on methods for manufacturing high-density electrodes having a higher energy density per unit volume, as electrodes for such high-capacity lithium secondary batteries.

In general, a secondary battery includes a positive electrode, a negative electrode, an electrolyte, and a separator. The negative electrode includes a negative electrode active material for intercalating and deintercalating lithium ions to and from the positive electrode, and silicon-based particles having a high discharge capacity may be used as the negative electrode active material.

In particular, in response to the demand for high-density energy batteries in recent years, research is being actively conducted on methods for increasing capacity by using a silicon-based compound, such as Si/C or Siox, having a capacity 10-fold or higher than that of a graphite-based material, in combination as a negative electrode active material. When compared with more typically used graphite, however, such silicon-based compounds that are high-capacity materials are excellent in capacity characteristic itself, but undergo rapid volume expansion during a charging process to disconnect a conductive path, resulting in deterioration in battery characteristics, and accordingly, the capacity decreases from the initial stage. In addition, for silicon-based negative electrodes, when the charging and discharging cycle is repeated, lithium ions are not uniformly charged in the depth direction of the negative electrode and reactions proceed on the surface, so that surface degradation is accelerated, and therefore, there is a need for improved performance in terms of battery cycle.

As described above, silicon-based active materials are materials with a much higher capacity than the graphite that is the most widely used material in lithium secondary batteries. However, due to the problems described above, the process of destroying/regenerating the solid electrolyte interface (SEI) layer continuously occurs. Accordingly, a larger amount of the electrolyte solution is used to regenerate the SEI layer, resulting in generation of a large amount of gas. When gas is generated, the electrode and the separator are separated due to the electrolyte solution, and as the gas is trapped, a distance between the positive electrode and the negative electrode increases, resulting in an increase in local resistance that causes a problem in that the life of the battery is drastically reduced.

Therefore, in order to solve the problem that occurs when a silicon-based compound is used as a negative electrode active material, a variety of methods are discussed, such as a method of controlling a drive potential, a method of additionally coating a thin film on an active material layer, a method of suppressing volume expansion itself such as a method of controlling a particle diameter of a silicon-based compound or a development of a binder capable of suppressing volume expansion of a silicon-based compound to prevent disconnection of a conductive path. In addition, research is being conducted to supplement the life characteristics of silicon-based negative electrodes by limiting a proportion of the silicon-based active material used during initial charging and discharging by a method of pre-lithiating the silicon-based active material layer, and imparting a reservoir role.

However, since the above methods may make the performance of the battery somewhat deteriorate, there is a limitation in the application thereof, so that there are still limitations in the commercialization of manufacturing negative electrode batteries having a high content of a silicon-based compound. In particular, as the proportion of the silicon-based active material included in the silicon-based active material layer increases, pre-lithiation is concentrated on the surface of the negative electrode, so that the silicon-based active material on the surface is somewhat damaged, and as non-uniform pre-lithiation occurs, problems with the improvement of life characteristics occurs.

Therefore, there is still a need for research on methods capable of solving the above-mentioned problems by suppressing gas generation even when the silicon-based compound is used as an active material.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### RELATED ART

Japanese Patent Application Publication No. 2009-080971

### SUMMARY

Aspects of the present disclosure relate to a negative electrode for a lithium secondary battery capable of suppressing gas generation by sensing generated gases (CO₂, H₂), which is a problem described in the related art, and improving cycle performance along with capacity characteristics of a lithium secondary battery by improving uniformity during pre-lithiation, while using a silicon-based active material for a negative electrode, a method for manufacturing the negative electrode for the lithium secondary battery, and the lithium secondary battery including the negative electrode.

The negative electrode for the lithium secondary battery according to aspects of the present disclosure solves the above problem by providing a specific ceramic layer on top of a negative electrode active material layer.

An exemplary embodiment of the present disclosure provides a negative electrode for a lithium secondary battery including: a negative electrode current collector layer; a silicon-based negative electrode active material layer provided at least one surface of the negative electrode current collector layer; and a ceramic layer provided on a surface of the silicon-based negative electrode active material layer opposite to a surface of the silicon-based negative electrode active material layer facing the negative electrode current collector layer, wherein the ceramic layer includes a ceramic layer composition or a dried product thereof, wherein a thickness of the ceramic layer is 0.5 μm or greater and 10 μm or less, wherein the ceramic layer composition includes ceramic and a binder, and wherein BaTiO₃ is included in an amount of 10 parts by weight or more and 50 parts by weight or less based on 100 parts by weight of the ceramic.

Another exemplary embodiment provides a method for manufacturing a negative electrode for a lithium secondary battery, the method including: preparing a negative electrode current collector layer; forming a negative electrode active material layer by applying a negative electrode active material layer composition to at least one surface of the negative electrode current collector layer; and forming a ceramic layer by applying a ceramic layer composition to a surface of the negative electrode active material layer opposite to a surface of the negative electrode active material layer facing the negative electrode current collector layer, wherein a thickness of the ceramic layer is 0.5 μm or greater and 10 μm or less, wherein the ceramic layer composition includes ceramic and a binder, and wherein BaTiO₃ is included in an amount of 10 parts by weight or more and 50 parts by weight or less based on 100 parts by weight of the ceramic.

Finally, according to an embodiment there is provided a lithium secondary battery including a positive electrode; the negative electrode for the lithium secondary battery according to the present disclosure; a separator provided between the positive electrode and the negative electrode; and an electrolyte.

The negative electrode for the lithium secondary battery according to an exemplary embodiment of the present disclosure has the silicon-based negative electrode active material layer, and includes the ceramic layer having a specific composition and thickness on top of the silicon-based negative electrode active material layer. In particular, a certain content of BaTiO₃ capable of sensing gas is included in the ceramic layer, so that a part of gas generated from the silicon-based negative electrode can be recovered, resulting in a reduction in gas generation.

By including the ceramic layer that can suppress the amount of gas generation as described above, according to certain aspects it is possible to suppress an increase in resistance and lithium precipitation due to an increase in electrode distance, which results from generation and separation of bubbles between the electrode and the separator. In addition, like a safety-reinforced separator (SRS) layer of the separator, it may be possible, according to certain aspects, to bring about some stability effects, resulting in an additional stability increase in the battery.

Additionally, according to certain aspects, the ceramic layer advantageously reduces the direct contact points between the silicon-based negative electrode and the lithium metal to increase the charge/discharge uniformity of the silicon-based negative electrode, resulting in an improvement in performance.

Further, according to certain aspects, by providing the ceramic layer on top of the silicon-based negative active material layer, a ceramic layer formed on the separator can be eliminated or minimized, allowing a material thickness of the separator to be reduced, resulting in excellent features in terms of process and cost.

As a result, the negative electrode for a lithium secondary battery according to aspects of the present disclosure may be characterized by the introduction of the ceramic layer having a specific thickness and composition in order to take advantage of an electrode to which a high content of Si particles is applied as a single-layer active material, and at the same time, to address issues of surface degradation, and uniformity and life characteristics due to gas generation during pre-lithiation, which issues may be caused when the high content of Si particles is applied to the electrode.

### BRIEF DESCRIPTION OF DRAWINGS

The accompanying drawings illustrate a preferred embodiment of the present disclosure and together with the foregoing disclosure, serve to provide further understanding of the technical features of the present disclosure, and thus, the present disclosure is not construed as being limited to the drawing.

FIG. 1 shows a stack structure of a negative electrode for a lithium secondary battery according to an exemplary embodiment of the present disclosure.

### EXPLANATION OF REFERENCE NUMERALS

10: ceramic layer
20: negative electrode active material layer
20a, b: surfaces of the negative electrode active material layer
30: negative electrode current collector layer
30a, b: surfaces of the negative electrode current collector

### DETAILED DESCRIPTION

Hereinafter, preferred embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation.

Before describing aspects of the present disclosure, some terms are first defined.

When one part “includes”, “comprises” or “has” one constituent element in the present specification, unless otherwise specifically described, this does not mean that another constituent element is excluded, but means that another constituent element may be further included.

In the present specification, ‘p to q’ means a range of ‘p or more and q or less’.

In this specification, the “specific surface area” is measured by the Brunauer-Emmett-Teller (BET) method, and specifically, is calculated from a nitrogen gas adsorption amount at a liquid nitrogen temperature (77K) by using BELSORP-mini II available from BEL Japan, Inc. That is, in the present disclosure, the BET specific surface area may refer to the specific surface area measured by the above measurement method.

In the present specification, “Dn” refers to a particle diameter distribution, and refers to a particle diameter at the no point in the cumulative distribution of the number of particles according to the particle diameter. That is, D50 is a particle diameter (average particle diameter) at the 50% point in the cumulative distribution of the number of particles according to the particle diameter, D90 is a particle diameter at the 90% point in the cumulative distribution of the number of particles according to the particle diameter, and D10 is a particle diameter at the 10% point in the cumulative distribution of the number of particles according to the particle diameter.

Meanwhile, the particle diameter distribution may be measured using a laser diffraction method. Specifically, after a powder to be measured is dispersed in a dispersion medium, the resultant dispersion is introduced into a commercially available laser diffraction particle size measurement apparatus (for example, Microtrac S3500) in which a difference in a diffraction pattern according to the particle size is measured, when a laser beam passes through particles, and then a particle size distribution is calculated.

In the present specification, the description “a polymer includes a certain monomer as a monomer unit” means that the monomer participates in a polymerization reaction and is included as a repeating unit in the polymer. In the present specification, when a polymer includes a monomer, this is interpreted as the same as that the polymer includes a monomer as a monomer unit.

In the present specification, it is understood that the term ‘polymer’ is used in a broad sense including a copolymer unless otherwise specified as ‘a homopolymer’.

In the present specification, a weight-average molecular weight (Mw) and a number-average molecular weight (Mn) are polystyrene converted molecular weights measured by gel permeation chromatography (GPC) while employing, as a standard material, a monodispersed polystyrene polymer (standard sample) having various degrees of polymerization commercially available for measuring a molecular weight. In the present specification, a molecular weight refers to a weight-average molecular weight unless particularly described otherwise.

Hereinafter, embodiments of the present disclosure will be described in detail with reference to the drawings so that one skilled in the art can readily implement the present disclosure. However, the present disclosure may be embodied in various different forms, and is not limited to the following descriptions.

An exemplary embodiment of the present disclosure provides a negative electrode for a lithium secondary battery including: a negative electrode current collector layer; a silicon-based negative electrode active material layer provided on at least one surface of the negative electrode current collector layer; and a ceramic layer provided on a surface of the silicon-based negative electrode active material layer opposite to a surface of the silicon-based negative electrode active material layer facing the negative electrode current collector layer, wherein the ceramic layer includes a ceramic layer composition or a dried product thereof, wherein a thickness of the ceramic layer is 0.5 μm or greater and 10 μm or less, wherein the ceramic layer composition includes ceramic and a binder, and wherein BaTiO₃ is included in an amount of 10 parts by weight or more and 50 parts by weight or less based on 100 parts by weight of the ceramic.

The negative electrode for a lithium secondary battery according to the present disclosure is characterized, in certain embodiments, by the introduction of the ceramic layer having a specific thickness and composition in order to take advantages of an electrode to which a high content of Si particles is applied as a single-layer active material, and at the same time, to address issues of surface degradation, and uniformity and life characteristics due to gas generation during pre-lithiation, which issues are caused when the high content of Si particles is applied to the electrode.

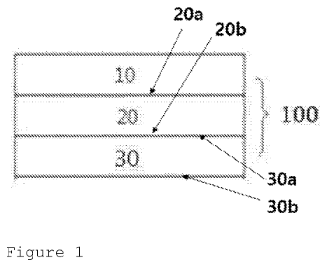

FIG. 1 shows a stack structure of a negative electrode for a lithium secondary battery according to an exemplary embodiment of the present disclosure. Specifically, a negative electrode 100 for a lithium secondary battery can be seen which includes a ceramic layer 10 and a negative electrode active material layer 20 on one surface of a negative electrode current collector layer 30. FIG. 1 shows that the negative electrode active material layer is formed on one surface of the negative electrode current collector layer, but the negative electrode active material layer may be formed on both surfaces of the negative electrode current collector layer.

Below, the negative electrode for a lithium secondary battery according to aspects of the present disclosure will be described in more detail.

Aspects of the present disclosure provide a negative electrode for a lithium secondary battery including: a negative electrode current collector layer; a silicon-based negative electrode active material layer provided on at least one, such as on one surface or both surfaces, of the negative electrode current collector layer; and a ceramic layer provided on a surface of the silicon-based negative electrode active material layer opposite to a surface of the silicon-based negative electrode active material layer facing the negative electrode current collector layer.

In an exemplary embodiment of the present disclosure, the negative electrode current collector layer generally has a thickness of 1 μm to 100 μm. Such a negative electrode current collector layer is not particularly limited as long as it has high conductivity without causing a chemical change in the battery. For example, copper, stainless steel, aluminum, nickel, titanium, fired carbon, copper or stainless steel each surface-treated with carbon, nickel, titanium, silver, or the like, an aluminum-cadmium alloy, or the like may be used. In addition, the negative electrode current collector layer may have microscopic irregularities formed on a surface to enhance a coupling force of the negative electrode active material, and may be used in various forms such as a film, a sheet, a foil, a net, a porous body, a foamed body, or a non-woven fabric body.

In an exemplary embodiment of the present disclosure, a thickness of the negative electrode current collector layer may be 1 μm or greater and 100 μm or less.

However, the thickness may be variously modified depending on a type and use of the negative electrode used, and is not limited thereto.

In an exemplary embodiment of the present disclosure, there is provided a negative electrode for a lithium secondary battery in which the silicon-based negative electrode active material layer includes a negative electrode active material layer composition, and the negative electrode active material layer composition includes one or more selected from the group consisting of a silicon-based active material, a negative electrode conductive material and a negative electrode binder.

In an exemplary embodiment of the present disclosure, the silicon-based active material may include one or more selected from the group consisting of SiOx (x=0), SiOx (0<x<2), SiC, and a Si alloy.

In an exemplary embodiment of the present disclosure, the silicon-based active material may include one or more selected from the group consisting of Siox (x=0), SiOx (0<x≤2) and a metal impurity, and may include 70 parts by weight or more of SiOx (x=0) based on 100 parts by weight of the silicon-based active material.

In another exemplary embodiment, the silicon-based active material may include one or more selected from the group consisting of Siox (x=0) and SiOx (0xx≤2), and may include 70 parts by weight or more of SiOx (x=0) based on 100 parts by weight of the silicon-based active material.

In another exemplary embodiment, SiOx (x=0) may be included in an amount of 70 parts by weight or more, preferably 80 parts by weight or more, and more preferably 90 parts by weight or more, and 100 parts by weight or less, preferably 99 parts by weight or less, and more preferably 95 parts by weight or less based on 100 parts by weight of the silicon-based active material.

In an exemplary embodiment of the present disclosure, for the silicon-based active material, pure silicon (Si) may be particularly used as the silicon-based active material. The use of pure silicon (Si) as the silicon-based active material may mean that, based on 100 parts by weight of the total silicon-based active material as described above, pure Si particles (SiOx (x=0)) that are not bonded to other particles or elements are included within the above range.

In an exemplary embodiment of the present disclosure, the silicon-based active material may be composed of SiOx (x=0).

The capacity of the silicon-based active material is significantly higher than that of a graphite-based active material that is typically used, so that there have been more attempts to apply the same. However, the volume expansion rate of the silicon-based active material during charging/discharging is high, so that, for example, only a small amount thereof is mixed and used with a graphite-based active material.

The negative electrode active material layer according to aspects of the present disclosure includes the silicon-based active material, and specifically, includes pure silicon particles including 70 parts by weight or more of Siox (x=0). In this case, according to certain aspects, when a high content of pure silicon particles is included, the capacity characteristics are excellent, and in order to solve deterioration in life characteristics due to a resulting non-uniform surface reaction, the ceramic layer of the present disclosure may be included.

In an exemplary embodiment of the present disclosure, the crystal grain size of the silicon-based active material may be 200 nm or less.

In another exemplary embodiment, the crystal grain size of the silicon-based active material may be 200 nm or less, preferably 130 nm or less, more preferably 110 nm or less, still more preferably 100 nm or less, specifically 95 nm or less, and more specifically 91 nm or less. The crystal grain size of the silicon-based active material may have a range of 10 nm or greater, preferably 15 nm or greater.

The silicon-based active material may have the crystal grain size described above, and the crystal grain size of the silicon-based active material may be controlled by changing a process condition in a manufacturing process. In this case, according to certain aspects, when the above range is satisfied, the crystal grain boundaries are widely distributed, and thus, the lithium ions can be uniformly intercalated during intercalating of lithium ions, thereby reducing the stress applied during intercalating of lithium ions into the silicon particles, and accordingly, mitigating breakage of the particles. As a result, according to certain aspects, characteristics capable of improving the life stability of the negative electrode are obtained. According to certain aspects, if the crystal grain size exceeds the above range, the crystal grain boundaries within the particles are narrowly distributed, and in this case, lithium ions may be non-uniformly intercalated into the particles, leading to large stress during the intercalating of ions, and accordingly, breakage of particles.

In an exemplary embodiment of the present disclosure, the silicon-based active material includes a crystal structure having a crystal grain distribution of 1 nm or greater and 200 nm or less, and an area ratio of the crystal structure based on a total area of the silicon-based active material may be 5% or less.

In another exemplary embodiment, the area ratio of the crystal structure based on the total area of the silicon-based active material may be 5% or less, or 3% or less, and 0.1% or greater.

That is, the silicon-based active material according to aspects of the present disclosure may have a crystal grain size of 200 nm or less, may be formed so that the size of one crystal structure is small, and may satisfy the above area ratio. Accordingly, the distribution of the crystal grain boundaries may be widened, and accordingly, the above-described effects may be exhibited.

In an exemplary embodiment of the present disclosure, the number of crystal structures included in the silicon-based active material may be 20 or more.

In another exemplary embodiment, the number of crystal structures included in the silicon-based active material may satisfy a range of 20 or more, 30 or more, or 35 or more, and 60 or less or 50 or less.

That is, as described above, when the crystal grain size of the silicon-based active material satisfies the above range and the number of crystal structures satisfies the above range, according to certain aspects the silicon-based active material itself can exhibit strength within an appropriate range. Therefore, according to some aspects, when such a silicon-based active material is included in an electrode, flexibility can be imparted and volume expansion can be effectively suppressed.

In the present disclosure, the crystal grain refers to a crystal particle in a metal or material, which is a collection of microscopically irregular shapes, and the crystal grain size may mean a diameter of the observed crystal grain particle. That is, in the present disclosure, the crystal grain size means a size of a domain sharing the same crystal direction in a particle, and is a different concept from a particle size or a size of a particle diameter that may be used to express a size of a material.

In an exemplary embodiment of the present disclosure, the crystal grain size can be calculated as a value of full width at half maximum (FWHM) through XRD analysis. The remaining values except L are measured through XRD analysis of the silicon-based active material, and the crystal grain size can be measured through the Debey-Scherrer equation showing that the FWHM and the crystal grain size are in inverse proportion. The Debey-Scherrer equation is as shown in Equation 1-1 below.

$$FWHM = K λ / L Cos θ \qquad [ Equation 1 - 1 ]$$

in Equation 1-1,

L is the crystal grain size, K is a constant, θ is a Bragg angle, and λ means a wavelength of X-ray.

In addition, the shapes of the crystal grains are diverse and can be measured in three dimensions. In general, the size of the crystal grain can be measured by a generally used circle method or diameter measurement method, but the present disclosure is not limited thereto.

In the diameter measurement method, the size of the crystal grain can be measured by drawing 5 to 10 parallel lines each having a length of L mm on a micrograph of a target particle, counting the number of crystal grains z on each line, and averaging them. In this case, only crystal grains that are wholly included on the line are counted, and crystal grains that are partially put (laid across) on the line are excluded. If the number of lines is P and the magnification is V, the average particle diameter can be calculated by Equation 1-2 below.

$$Dm = ( L * P * {10}^{3} ) / ( zV ) ( um ) \qquad [ Equation 1 - 2 ]$$

In addition, the circle method is a method in which a circle with a predetermined diameter is drawn on a micrograph of a target particle, and then an average area of crystal grains is calculated by the number of crystal grains in the circle and the number of crystal grains laid across the boundary line, and the average area can be calculated by Equation 1-3 below.

$$Fm = ( Fk ⋆ {10}^{6} ) / ( ( 0.67 n + z ) {V}^{2} ) ( {um}^{2} ) \qquad [ Equation 1 - 3 ]$$

In Equation 1-3, Fm is an average particle area, Fk is a measurement area on the photograph, z is the number of particles in a circle, n is the number of particles laid across the circle, and V is a magnification of a microscope.

In an exemplary embodiment of the present disclosure, the silicon-based active material may have a specific surface area of 0.25 m²/g or greater.

In another exemplary embodiment, the silicon-based active material may have a specific surface area of 0.25 m²/g or greater, preferably 0.28 m²/g or greater, and more preferably 0.30 m²/g or greater, specifically 0.31 m²/g or greater, and more specifically 0.32 m²/g or greater. The silicon-based active material may satisfy a range of a specific surface area of 3 m²/g or less, preferably 2.5 m²/g or less, and more preferably 2.2 m²/g or less. The specific surface area may be measured according to DIN 66131 (using nitrogen).

The silicon-based active material can have the specific surface area described above, and the specific surface area of the silicon-based active material may be controlled by changing a process condition of a manufacturing process and a growth condition of the silicon-based active material. That is, when the silicon-based active material is manufactured using the manufacturing method according to aspects of the present disclosure, a rough surface is provided that results in a larger specific surface area, as compared with particles with the same particle size. In this case, the above range can be satisfied, and thus, according to certain aspects, the bonding force with the binder can be increased, leading to a reduction in the formation of cracks in the electrode due to repeating charge and discharge cycles.

In addition, according to certain aspects, the lithium ions can be uniformly intercalated during intercalation of lithium ions, resulting in reduction in stress applied during intercalation of lithium ions into the silicon particles, and accordingly, reduction in breakage of the particles. As a result, according to certain aspects, characteristics capable of improving the life stability of the negative electrode may be obtained. If the specific surface area is less than the above range, the surface that is formed is smooth even with the same particle size, which can result in a decrease in the bonding force with the binder, and cracks of the electrode. In this case, lithium ions may be non-uniformly intercalated into the particles, resulting in an increase in the stress due to the ion intercalation, and breakage of particles.

In an exemplary embodiment of the present disclosure, the silicon-based active material satisfies a range in Equation 2-1 below.

$$X 1 / Y 1 \leq 0.960 \qquad [ Equation 2 - 1 ]$$

in Equation 2-1,

X1 refers to an actual area of the silicon-based active material, and Y1 refers to an area of a spherical particle with the same circumference as the silicon-based active material.

The measurement of Equation 2-1 above may be performed using a particle shape analyzer. Specifically, the silicon-based active material according to the present disclosure may be scattered on a glass plate through air injection, and then a shape of 10,000 silicon-based active material particles in a photograph obtained by capturing a shadow image of the scattered silicon-based active material particles may be measured. In this case, Equation 2-1 is a value expressing an average of 10,000 particles. Equation 2-1 according to the present disclosure can be measured from the above image, and Equation 2-1 can be expressed as sphericity (circularity) of the silicon-based active material. The sphericity may also be expressed by [4π *actual area of silicon-based active material/(circumference)²].

In an exemplary embodiment of the present disclosure, the sphericity of the silicon-based active material may be 0.960 or less, for example, 0.957 or less. The sphericity of the silicon-based active material may be 0.8 or higher, for example, 0.9 or higher, specifically 0.93 or higher, more specifically 0.94 or higher, for example, 0.941 or higher.

In an exemplary embodiment of the present disclosure, the silicon-based active material satisfies a range in Equation 2-2 below.

$$X 2 / Y 2 \leq 0.995 \qquad [ Equation 2 - 2 ]$$

in Equation 2-2,

Y2 is the actual circumference of the silicon-based active material, and X2 is the circumference of the circumscribed figure of the silicon-based active material.

The measurement of Equation 2-2 above may be performed using a particle shape analyzer. Specifically, the silicon-based active material according to aspects of the present disclosure may be scattered on a glass plate through air injection, and then a shape of 10,000 silicon-based active material particles in a photograph obtained by capturing a shadow image of the scattered silicon-based active material particles may be measured. In this case, Equation 2-2 is a value expressing an average of 10,000 particles. Equation 2-2 according to the present disclosure can be measured from the above image, and Equation 2-2 can be expressed as convexity of the silicon-based active material.

In an exemplary embodiment of the present disclosure, a range of X2/Y23≤0.996, preferably X2/Y2≤0.995 may be satisfied, and a range of 0.8≤x2/Y2, preferably 0.9≤x2/Y2, more preferably 0.95≤x2/Y2, specifically 0.98≤X2/Y2 may be satisfied.

The smaller the value of Equation 2-1 or Equation 2-2, the greater the roughness of the silicon-based active material that may be provided. According to certain aspects, when the silicon-based active material with the above range is used, the bonding force with the binder can be increased, leading to reduction in cracks of the electrode due to the repeating of the charge/discharge cycle.

In an exemplary embodiment of the present disclosure, the silicon-based active material may include silicon-based particles having a particle size distribution of 0.01 μm or greater and 30 μm or less.

The description ‘the silicon-based active material includes silicon-based particles having a particle size distribution of 0.01 μm or greater and 30 μm or less’ means that the silicon-based active material includes a plurality of individual silicon-based particles having a particle size within the above range, and the number of silicon-based particles included is not limited.

When the silicon-based particle is spherical, the particle size thereof can be expressed as its diameter. However, even when the silicon-based particle has a shape other than spherical, the particle size can be measured in contrast to the case of the spherical shape, and the particle size of the individual silicon-based particle can be measured by a method that is generally known in the art.

An average particle diameter (D50) of the silicon-based active material according to aspects of the present disclosure may be 5 μm to 10 μm, specifically 5.5 μm to 8 μm, and more specifically 6 μm to 7 μm. According to certain aspects, if the average particle diameter is less than 5 μm, the specific surface area of the particle can excessively increase, which can cause the viscosity of the negative electrode slurry to excessively increase. Accordingly, in certain embodiments, the particles constituting the negative electrode slurry are not smoothly dispersed. In addition, according to certain aspects, if the size of the silicon-based active material is excessively small, a contact area between the silicon particles and the conductive material may be reduced due to the composite consisting of the conductive material and the binder in the negative electrode slurry, so that the likelihood of disconnection of the conductive network increases, thereby lowering the capacity retention rate. On the other hand, if the average particle diameter is greater than 10 μm, excessively large silicon particles can exist, so that the surface of the negative electrode is not smooth, which can cause current density unevenness during charging and discharging. Additionally, if the silicon particles are excessively large, the phase stability of the negative electrode slurry can become unstable, and result in the deteriorating processability. As a result, the capacity retention rate of the battery may decrease.

In an exemplary embodiment of the present disclosure, the silicon-based active material generally has a characteristic BET specific surface area. The BET specific surface area of the silicon-based active material is preferably 0.01 to 150.0 m²/g, more preferably 0.1 to 100.0 m²/g, particularly preferably 0.2 to 80.0 m²/g, and most preferably 0.2 to 18.0 m²/g. The BET specific surface area is measured in accordance with DIN 66131 (using nitrogen).

In an exemplary embodiment of the present disclosure, the silicon-based active material may be present, for example, in a crystalline or amorphous form, and is preferably not porous. The silicon particles are preferably spherical or splinter-shaped particles. Alternatively, but less preferably, the silicon particles may also have a fiber structure or be present in the form of a silicon-containing film or coating.

In an exemplary embodiment of the present disclosure, there is provided the negative electrode composition in which the silicon-based active material is included in an amount of 70 parts by weight or more based on 100 parts by weight of the negative electrode active material composition.

In another exemplary embodiment, the silicon-based active material may be included in an amount of 70 parts by weight or more, preferably 75 parts by weight or more, and more preferably 80 parts by weight or more, and 95 parts by weight or less, preferably 90 parts by weight or less, and more preferably 85 parts by weight or less, based on 100 parts by weight of the negative electrode composition.

Although the negative electrode active material layer composition according to aspects of the present disclosure may use silicon-based active material with a significantly high capacity within the above range, the negative electrode active material layer composition may also uses a ceramic layer described below, which may be capable of solving the problems of surface degradation during charging and discharging, and uniformity and gas generation during pre-lithiation without lowering the overall capacity performance of the negative electrode. In addition, a specific negative electrode conductive material and negative electrode binder capable of controlling the volume expansion rate during charging and discharging may be used, according to certain aspects, so that even when a silicon-based active material is included within the above range, the negative electrode active material layer composition does not degrade the performance of the negative electrode, and has excellent output characteristics during charging and discharging.

In an exemplary embodiment of the present disclosure, the silicon-based active material may have a non-spherical shape and its sphericity (circularity) is, for example, 0.9 or less, for example, 0.7 to 0.9, for example 0.8 to 0.9, and for example 0.85 to 0.9.

In the present disclosure, the sphericity (circularity) is determined by Equation 1 below, in which A is an area and P is a boundary line.

$$4 π A / {P}^{2} \qquad [ Equation 1 ]$$

In the related art, it is typical to use only graphite-based compounds as the negative electrode active material. However, in recent years, as the demand for high-capacity batteries is increasing, attempts to mix and use silicon-based compounds are increasing in order to increase capacity. However, in the case of a silicon-based active material, even when the characteristics of the silicon-based active material itself are adjusted as described above, the volume may rapidly expand during the charging/discharging, thereby causing problems including damaging the conductive path formed in the negative electrode active material layer.

Therefore, in an exemplary embodiment of the present disclosure, there is provided a negative electrode for a lithium secondary battery in which the negative electrode active material layer composition includes one or more selected from the group consisting of a negative electrode conductive material and a negative electrode binder.

In an exemplary embodiment of the present disclosure, the negative electrode conductive material may include one or more selected from the group consisting of a particulate conductive material, a planar conductive material and a linear conductive material.

In an exemplary embodiment of the present disclosure, the particulate conductive material refers to a conductive material that may be used for improving conductivity of the negative electrode, has conductivity without causing a chemical change and has a spherical or point shape. Specifically, the particulate conductive material may be one or more species selected from the group consisting of natural graphite, artificial graphite, carbon black, acetylene black, Ketjen black, channel black, furnace black, lamp black, thermal black, conductive fiber, fluorocarbon, aluminum powder, nickel powder, zinc oxide, potassium titanate, titanium oxide, and a polyphenylene derivative, and preferably may include carbon black in terms of high conductivity and excellent dispersibility.

In an exemplary embodiment of the present disclosure, the particulate conductive material may have a BET specific surface area of 40 m²/g or greater and 70 m²/g or less, preferably 45 m²/g or greater and 65 m²/g or less, and more preferably 50 m²/g or greater and 60 m²/g or less.

In an exemplary embodiment of the present disclosure, a content of the functional group (volatile matter) of the particulate conductive material may satisfy a range of 0.01% or more and 1% or less, preferably 0.01% or more and 0.3% or less, and more preferably 0.01% or more and 0.1% or less.

In particular, according to certain embodiments, when the content of the functional group of the particulate conductive material satisfies the above range, a functional group is present on a surface of the particulate conductive material, so that the particulate conductive material can be smoothly dispersed in a solvent when water is used as the solvent.

In an exemplary embodiment of the present disclosure, the particulate conductive material having the content of the functional group within the range described above is included together with the silicon-based active material, and the content of the functional group can be adjusted according to a degree of heat treatment of the particulate conductive material.

That is, in the manufacture of a particulate conductive material, a high functional group content may mean that a large amount of foreign materials are present, and a low functional group content may mean that heat treatment processing has been conducted more frequently.

In an exemplary embodiment of the present disclosure, the particle diameter of the particulate conductive material may be 10 nm to 100 nm, preferably 20 nm to 90 nm, and more preferably 20 nm to 60 nm.

In an exemplary embodiment of the present disclosure, the negative electrode conductive material may include a planar conductive material.

The planar conductive material can serve, in certain embodiments, to improve conductivity by increasing surface contact between silicon particles in the negative electrode, and at the same time, to suppress the disconnection of the conductive path due to the volume expansion, and may be expressed as a plate-like conductive material or a bulk-type conductive material.

In an exemplary embodiment of the present disclosure, the planar conductive material may include one or more selected from the group consisting of plate-like graphite, graphene, graphene oxide, and graphite flake, and preferably may be plate-like graphite.

In an exemplary embodiment of the present disclosure, the average particle diameter (D50) of the planar conductive material may be 2 μm to 7 μm, specifically 3 μm to 6 μm, and more specifically 4 μm to 5 μm. When the above range is satisfied, the sufficient particle size may result in easy dispersion without causing an excessive increase in viscosity of the negative electrode slurry. Therefore, the dispersion effect may be excellent when dispersing using the same equipment and time.

In an exemplary embodiment of the present disclosure, the planar conductive material may have D10 of 0.5 μm or greater and 1.5 μm or less, D50 of 2.5 μm or greater and 3.5 μm or less and D90 of 7.0 μm or greater and 15.0 μm or less.

In an exemplary embodiment of the present disclosure, for the planar conductive material, a planar conductive material with a high specific surface area having a high BET specific surface area or a planar conductive material with a low specific surface area may be used.

In an exemplary embodiment of the present disclosure, for the planar conductive material, a planar conductive material with a high specific surface area or a planar conductive material with a low specific surface area may be used without limitation. However, in particular, the planar conductive material according to aspects of the present disclosure can be affected to some extent in the electrode performance by the dispersion effect, so that a planar conductive material with a low specific surface area that does not cause a problem in dispersion may be used particularly preferably.

In an exemplary embodiment of the present disclosure, the planar conductive material may have a BET specific surface area of 5 m²/g or greater.

In another exemplary embodiment, the planar conductive material may have a BET specific surface area of 5 m²/g or greater and 500 m²/g or less, preferably 5 m²/g or greater and 300 m²/g or less, and more preferably 5 m²/g or greater and 250 m²/g or less.

In another exemplary embodiment, the planar conductive material is a planar conductive material with a high specific surface area, and the BET specific surface area may satisfy a range of 50 m²/g or greater and 500 m²/g or less, preferably 80 m²/g or greater and 300 m²/g or less, and more preferably 100 m²/g or greater and 300 m²/g or less.

In another exemplary embodiment, the planar conductive material is a planar conductive material with a low specific surface area, and the BET specific surface area may satisfy a range of 5 m²/g or greater and 40 m²/g or less, preferably 5 m²/g or greater and 30 m²/g or less, and more preferably 5 m²/g or greater and 25 m²/g or less.

Other conductive materials may include linear conductive materials such as carbon nanotubes. The carbon nanotubes may be bundle-type carbon nanotubes. The bundle-type carbon nanotubes may include a plurality of carbon nanotube units. Specifically, the term ‘bundle type’ herein refers to, unless otherwise specified, a bundle or rope-shaped secondary shape in which a plurality of carbon nanotube units are aligned side by side in such an orientation that longitudinal axes of the carbon nanotube units are substantially the same, or are entangled. The carbon nanotube unit has a graphite sheet having a cylindrical shape with a nano-sized diameter, and has an sp2 bonding structure. In this case, the characteristics of a conductor or a semiconductor may be exhibited depending on the rolled angle and structure of the graphite sheet. As compared with entangled-type carbon nanotubes, the bundle-type carbon nanotubes can be more uniformly dispersed during the manufacture of the negative electrode, and can form more smoothly a conductive network in the negative electrode to improve the conductivity of the negative electrode.

In the exemplary embodiment of the present disclosure, the linear conductive material may include single walled carbon nanotubes (SWCNTs) or multi-walled carbon nanotubes (MWCNTs).

In an exemplary embodiment of the present disclosure, there is provided a negative electrode active material layer composition in which the negative electrode conductive material is included in an amount of 10 parts by weight or more and 40 parts by weight or less based on 100 parts by weight of the negative electrode active material layer composition.

In another exemplary embodiment, the negative electrode conductive material may be included in an amount of 10 parts by weight or more and 40 parts by weight or less, preferably 10 parts by weight or more and 30 parts by weight or less, and more preferably 10 parts by weight or more and 25 parts by weight or less based on 100 parts by weight of the negative electrode active material layer composition.

In an exemplary embodiment of the present disclosure, there is provided a negative electrode for a lithium secondary battery in which the negative electrode conductive material includes a planar conductive material and a linear conductive material and the planar conductive material is included in an amount of 80 parts by weight or more and 99.9 parts by weight or less based on 100 parts by weight of the negative electrode conductive material. In another exemplary embodiment, the planar conductive material may be included in an amount of 80 parts by weight or more and 99.9 parts by weight or less, preferably 90 parts by weight or more and 99.9 parts by weight or less, and more preferably 95 parts by weight or more and 99.9 parts by weight or less based on 100 parts by weight of the negative electrode conductive material.

In another exemplary embodiment, the linear conductive material may be included in an amount of 0.1 part by weight or more and 20 parts by weight or less, preferably 0.1 part by weight or more and 10 parts by weight or less, and more preferably 0.1 part by weight or more and 5 parts by weight or less, based on 100 parts by weight of the negative electrode conductive material.

In particular, in an exemplary embodiment of the present disclosure, the negative electrode conductive material includes the planar conductive material and the linear conductive material and the composition and ratio described above are satisfied, respectively, and as such the lifespan characteristics of an existing lithium secondary battery are not significantly affected, and the number of points where charging and discharging are possible can be increased, so that output characteristics can be excellent at a high C-rate.

The negative electrode conductive material according to aspects of the present disclosure has a completely different configuration from a positive electrode conductive material that is applied to the positive electrode. That is, the negative electrode conductive material according to aspects of the present disclosure may serve to hold the contact between silicon-based active materials whose volume expansion of the electrode may be very large due to charging and discharging, whereas the positive electrode conductive material may serve to impart some conductivity while serving as a buffer when roll-pressed, and may be completely different from the negative electrode conductive material of the present disclosure in terms of configuration and role.

In addition, the negative electrode conductive material according to aspects of the present disclosure is applied to a silicon-based active material, and may have a completely different configuration from that of a conductive material that is applied to a graphite-based active material. That is, since a conductive material that is used for an electrode having a graphite-based active material simply has smaller particles than the active material, the conductive material has characteristics of improving output characteristics and imparting some conductivity, and is completely different from the negative electrode conductive material that is applied together with the silicon-based active material as in aspects of the present disclosure, in terms of configuration and role.

In an exemplary embodiment of the present disclosure, the planar conductive material that may be used as the negative electrode conductive material described above has a different structure and role from those of the carbon-based active materials that are generally used as the existing negative electrode active material. Specifically, the carbon-based active material that is used as the negative electrode active material may be artificial graphite or natural graphite, and refers to a material that is processed and used in a spherical or particulate shape so as to facilitate storage and release of lithium ions.

On the other hand, the planar conductive material that may be used as the negative electrode conductive material is a material having a plane or plate-like shape, and may be expressed as plate-like graphite. That is, the planar conductive material may be a material that is included so as to maintain a conductive path in the negative electrode active material layer, and includes a material for securing a conductive path in a planar shape inside the negative electrode active material layer, rather than playing a role in storing and releasing lithium.

That is, in aspects of the present disclosure, the use of plate-like graphite as a conductive material means that graphite is processed into a planar or plate-like shape and used as a material for securing a conductive path rather than playing a role in storing or releasing lithium. In this case, the negative electrode active material included together has high-capacity characteristics with respect to storing and releasing lithium, and serves to store and release all lithium ions transferred from the positive electrode.

On the other hand, in the present disclosure, the use of a carbon-based active material as an active material means that the carbon-based active material is processed into a particulate or spherical shape and used as a material for storing or releasing lithium.

That is, in an exemplary embodiment of the present disclosure, artificial graphite or natural graphite, which is a carbon-based active material, has a particulate shape, and a BET specific surface area thereof may satisfy a range of 0.1 m²/g or greater and 4.5 m²/g or less. In addition, plate-like graphite, which is a planar conductive material, has a planar shape, and a BET specific surface area thereof may be 5 m²/g or greater.

In an exemplary embodiment of the present disclosure, the negative electrode binder may include at least one selected from the group consisting of polyvinylidenefluoride-hexafluoropropylene copolymer (PVDF-CO-HFP), polyvinylidenefluoride, polyacrylonitrile, polymethylmethacrylate, polyvinyl alcohol, carboxymethylcellulose (CMC), starch, hydroxypropylcellulose, regenerated cellulose, polyvinylpyrrolidone, polytetrafluoroethylene, polyethylene, polypropylene, polyacrylic acid, ethylene-propylene-diene monomer (EPDM), sulfonated EPDM, styrene butadiene rubber (SBR), fluoro rubber, poly acrylic acid, and the above-described materials in which a hydrogen is substituted with Li, Na, Ca, etc., and may also include various copolymers thereof.

The negative electrode binder according to an exemplary embodiment of the present disclosure serves to hold the active material and the conductive material together in order to prevent distortion and structural deformation of the negative electrode structure in volume expansion and relaxation of the silicon-based active material. When such roles are satisfied, all of the general binders can be applied. Specifically, an aqueous binder may be used, and more specifically, a PAM-based binder may be used.

In an exemplary embodiment of the present disclosure, the negative electrode binder may be included in an amount of 30 parts by weight or less, preferably 25 parts by weight or less, and more preferably 20 parts by weight or less, and 5 parts by weight or more, and 10 parts by weight or more, based on 100 parts by weight of the negative electrode active material layer composition.

In particular, the negative electrode binder according to aspects of the present disclosure may use an aqueous binder as it uses the silicon-based active material with high rigidity. The aqueous binder is a polymer that exhibits very high rigidity after drying. The negative electrode active material layer composition according to aspects of the present disclosure can includes the aqueous binder, and thus, if an aqueous ceramic layer is coated and dried on top of the aqueous silicon-based negative electrode active material layer, the surface will be mixed due to water and inter-mixing may occur no matter how quickly the ceramic layer is dried. In order to solve the above problem, the ceramic layer according to aspects of the present disclosure uses an organic-based binder and an organic-based solvent to allow easy dispersion of the ceramic and the organic-based binder without affecting the aqueous negative electrode, leading to a very dense coating on the negative electrode active material layer.

In an exemplary embodiment of the present disclosure, a ceramic layer provided on a surface of the silicon-based negative electrode active material layer opposite to a surface of the silicon-based negative electrode active material layer facing the negative electrode current collector layer is included.

As described above, the negative electrode for a lithium secondary battery according to aspects of the present disclosure includes the ceramic layer, and may also include the above-described negative electrode active material, and may thereby according to some aspects solve the problems of surface degradation during charging and discharging, and uniformity and life characteristics due to gas generation during pre-lithiation while maintaining the characteristics of high capacity and high density.

Specifically, the biggest reason why gas is generated from a Si-based negative electrode is because the volume expansion/contraction of the Si active material is large, resulting in destruction and regeneration of an SEI layer. In other words, as the process of destroying/regenerating the SEI layer continuously proceeds and Si is used to a large extent, if particles are crushed, a reaction can occur whereby a new Si surface is generated and accordingly a new SEI layer is additionally generated. As a result, gas is generated and exists as resistance between electrodes, degrading performance. In order to solve the problem, according to certain aspects, a ceramic layer described below is used on top of the negative electrode active material layer.

In an exemplary embodiment of the present disclosure, the ceramic layer may include a ceramic layer composition or a dried product thereof.

According to certain aspects, including the ceramic layer composition may mean that the ceramic layer includes the ceramic layer composition as is. In addition, including the dried product of the ceramic layer composition may refer to a case in which all organic-based solvents that may be included in the ceramic layer composition are removed after drying and are not included in the ceramic layer.

In an exemplary embodiment of the present disclosure, a thickness of the ceramic layer may be 0.5 μm or greater and 10 μm or less.

In another exemplary embodiment, the thickness of the ceramic layer may satisfy 0.5 μm or greater and 8 μm or less, and preferably 2 μm or greater and 6 μm or less.

When the thickness of the ceramic layer satisfies the above range as described above, according to certain aspects, the effect of improving stability can be obtained by controlling a rate of pre-lithiation during pre-lithiation. If the thickness of the ceramic layer exceeds the above range, in certain aspects, problems such as deterioration in the performance of the negative electrode may occur, and the efficiency may be rather reduced during pre-lithiation. In addition, if the thickness of the ceramic layer is less than the above range, it may not be easy to control the rate of pre-lithiation, which may lead to a problem of shortening the life due to electrode degradation resulting from a surface reaction on the top of the negative electrode active material layer.

In addition, it could be confirmed that gas adsorption characteristics were particularly excellent when the above range was satisfied.

In an exemplary embodiment of the present disclosure, the ceramic layer composition may include ceramic and a binder, and the ceramic may include 10 parts by weight or more and 50 parts by weight or less of BaTiO₃ based on 100 parts by weight of the ceramic.

More specifically, the ceramic may include 10 parts by weight or more and 50 parts by weight or less, preferably 15 parts by weight or more and 40 parts by weight or less, and more preferably 20 parts by weight or more and 35 parts by weight or less of BaTiO₃ based on 100 parts by weight of the ceramic.

In an exemplary embodiment of the present disclosure, the ceramic may be used without limitation as long as it can serve as a ceramic layer. However, according to certain aspects, there is provided a negative electrode for a lithium secondary battery in which the ceramic includes one or more selected from the group consisting of, specifically, Al₂O₃, ZrO₂, SiO₂, TiO₂, Zno, BaTiO₃, SrTiO₃, CaCO₃, CaO, CeO₂, NiO, MgO, SnO₂, Y₂O₃, Pb(Zr,Ti)O₃ (PZT), (Pb,La) (Zr,Ti)O₃ (PLZT), Pb(Mg_{1/3}Nb_{2/3})O₃—PbTiO₃ (PMN-PT) and hafnia (HfO₂).

As described above, various ceramics can be used without limitation, but among them, aspects of the present disclosure may be characterized in that BaTiO₃ is included in an amount of the weight part described above. The ceramic can include BaTiO₃, which has the most effective structure for containing the gas generated from the negative electrode, in an amount of parts by weight as described above, and may thus be very excellent in gas adsorption properties, and can also have a feature of being able to serve as a buffer layer when it further includes another ceramic.

In an exemplary embodiment of the present disclosure, the ceramic includes BaTiO₃ and Al₂O₃, and includes BaTiO₃ in an amount of 10 parts by weight or more and 50 parts by weight or less based on 100 parts by weight of the ceramic.

Specifically, according to one aspect, the ceramic includes BaTiO₃ and Al₂O₃ and may satisfy a weight ratio of BaTiO₃:Al₂O₃=80:20.

In an exemplary embodiment of the present disclosure, the ceramic layer composition may further include a solvent. In this case, according to certain aspects, all solvents may be removed when forming a ceramic layer.

In an exemplary embodiment of the present disclosure, there is provided a negative electrode for a lithium secondary battery in which the solvent includes one or more selected from the group consisting of N-methyl pyrrolidone (NMP), dimethyl formamide (DMF), acetone, and dimethyl acetamide.

In an exemplary embodiment of the present disclosure, there is provided a negative electrode for a lithium secondary battery in which the binder is polyvinylidene fluoride (PVdF) or polyvinylidene fluoride-hexafluoropropylene (PVdF-HFP).

In an exemplary embodiment of the present disclosure, there is provided a negative electrode for a lithium secondary battery in which an adhesive strength is 10 gf/15 mm or higher and 100 gf/15 mm or less, for bonding of a lithium metal layer to a surface of the ceramic layer that is opposite to a surface of the ceramic layer facing the negative electrode active material layer and then allowing to stand at 23° C. for 10 seconds to 2 minutes.

The adhesive strength was measured at an angle of 90° and at a rate of 5 mm/s with a peel strength measuring apparatus using a 3M 9070 tape. Specifically, one surface of a lithium metal layer of a negative electrode in which the lithium metal layer was stacked on top of the ceramic layer was bonded to one surface of a slide glass (3M 9070 tape) to which an adhesive film was attached. Then, it was attached by reciprocating a 2 kg rubber roller 5 to 10 times, and the adhesive strength (peeling strength) was measured at a rate of 5 mm/s in an angular direction of 90°. In this case, the adhesive strength can be measured under conditions of 23° C. and normal pressure.

In an exemplary embodiment of the present disclosure, the normal pressure may mean a pressure in a state where a specific pressure is not applied or lowered, and may be used as the same sense as the atmospheric pressure. The normal pressure may be usually expressed as 1 atm.

In an exemplary embodiment of the present disclosure, the adhesive strength may be 10 gf/15 mm or higher and 100 gf/15 mm or less, preferably 15 gf/15 mm or higher and 95 gf/15 mm or less, and more preferably 20 gf/15 mm or higher and 50 gf/15 mm or less for bonding of a lithium metal layer to a surface of the ceramic layer that is opposite to a surface of the ceramic layer facing the negative electrode active material layer and then allowing to stand at 23° C. for 10 seconds to 2 minutes.

As described above, in a case where the adhesive strength between the ceramic layer and the lithium metal layer satisfies the above range, when transferring lithium metal during the pre-lithiation process, especially using the transfer process, the favorable adhesive strength between the lithium metal layer and the ceramic layer may ensure transferability and may not cause problems such as reverse transferring, and so may allow a smooth pre-lithiation process.

In an exemplary embodiment of the present disclosure, there is provided a negative electrode for a lithium secondary battery in which the ceramic is included in an amount of 60 parts by weight or more and 95 parts by weight or less and the binder is included in an amount of 5 parts by weight or more and 40 parts by weight or less based on 100 parts by weight of the ceramic layer composition. In this case, any organic-based solvent included in the ceramic layer composition is not an active substance, so 100 parts by weight of the ceramic layer composition may mean parts by weight including only the ceramic and binder.

In an exemplary embodiment of the present disclosure, the ceramic may satisfy 60 parts by weight or more and 95 parts by weight or less, preferably 65 parts by weight or more and 90 parts by weight or less, and more preferably 70 parts by weight or more and 90 parts by weight or less based on 100 parts by weight of the ceramic layer composition.

In an exemplary embodiment of the present disclosure, the binder may satisfy 5 parts by weight or more and 40 parts by weight or less, preferably 10 parts by weight or more and 35 parts by weight or less, and more preferably 10 parts by weight or more and 30 parts by weight or less based on 100 parts by weight of the ceramic layer composition.

According to certain aspects the ceramic layer composition includes the binder and ceramic in the above contents as described above, and as such the binder and ceramic may be improved in terms of the dispersibility and formed uniformly in the ceramic layer, allowing the rate of pre-lithiation to be smoothly controlled and satisfying an appropriate viscosity range to improve the coating density when coating the ceramic layer.

In an exemplary embodiment of the present disclosure, a thickness of the negative electrode active material layer may be 10 μm or greater and 200 μm.

In an exemplary embodiment of the present disclosure, the negative electrode for a lithium secondary battery may be a pre-lithiated negative electrode.

An exemplary embodiment of the present disclosure provides a method for manufacturing a negative electrode for a lithium secondary battery, the method including: preparing a negative electrode current collector layer; forming a negative electrode active material layer by applying a negative electrode active material layer composition to at least one surface of the negative electrode current collector layer; and forming a ceramic layer by applying a ceramic layer composition to a surface of the negative electrode active material layer opposite to a surface of the negative electrode active material layer facing the negative electrode current collector layer, wherein a thickness of the ceramic layer is 0.5 μm or greater and 10 μm or less, wherein the ceramic layer composition includes ceramic and a binder, and wherein BaTiO₃ is included in an amount of 10 parts by weight or more and 50 parts by weight or less based on 100 parts by weight of the ceramic.

In the method for manufacturing a negative electrode, according to certain aspects, the above-described descriptions may be applied to the composition and content included in each step.

An exemplary embodiment of the present disclosure includes forming a negative electrode active material layer by applying a negative electrode active material layer composition on at least on surface, such as on one surface or both surfaces, of the negative electrode current collector layer.

That is, the above step is a step of forming a negative electrode active material layer on the negative electrode current collector layer, and may mean forming the active material layer on a surface facing the current collector layer.

In an exemplary embodiment of the present disclosure, the applying of the negative electrode active material layer composition may include applying and drying a negative electrode slurry including a negative electrode active material layer composition, and a negative electrode slurry solvent.

In this case, according to certain aspects, a solid content of the negative electrode slurry may satisfy a range of 10% to 40%.

In an exemplary embodiment of the present disclosure, the forming of the negative electrode active material layer may include mixing the negative electrode slurry, and coating the mixed negative electrode slurry on at least one surface, such as on one surface or both surfaces, of the negative electrode current collector layer, and in certain aspects the coating may be performed using a coating method that is commonly used in the art.

Thereafter, an exemplary embodiment of the present disclosure includes forming a ceramic layer by applying a ceramic layer composition on a surface of the negative electrode active material layer opposite to a surface of the negative electrode active material layer facing the negative electrode current collector layer.

In an exemplary embodiment of the present disclosure, there is provided a method for manufacturing a negative electrode for a lithium secondary battery including drying an organic-based solvent in the ceramic layer composition through drying and rolling after applying the ceramic layer composition.

In an exemplary embodiment of the present disclosure, the negative electrode slurry solvent may be used without limitation as long as it can dissolve and disperse the negative electrode active material layer composition, and specifically, water or N-methyl-2-pyrrolidone (NMP) may be used.

In an exemplary embodiment of the present disclosure, there is provided a method for manufacturing a negative electrode for a lithium secondary battery, the method including pre-lithiating a negative electrode in which the negative electrode active material layer and the ceramic layer are formed on the negative electrode current collector layer, wherein the step of pre-lithiating the negative electrode includes a lithium electroplating process, a lithium metal transfer process, a lithium metal deposition process, or a stabilized lithium metal powder (SLMP) coating process.

According to certain embodiments, the negative electrode for a lithium secondary battery as described above includes SiOx (x=0) for enhancing capacity characteristics as the negative electrode active material layer and includes the ceramic layer with the specific composition and thickness described above, so that it can retain the advantages of rapid charging as they are. That is, as compared with a case where only a negative electrode active material layer is applied, the ceramic layer has the above composition, enabling a uniform pre-lithiation process on top of the negative electrode and thus further improving the life.

In an exemplary embodiment of the present disclosure, a porosity of the negative electrode active material layer may satisfy a range of 10% or greater and 60% or less.

In another exemplary embodiment, the porosity of the negative electrode active material layer may satisfy a range of 10% or greater and 60% or less, preferably 20% or greater and 50% or less, and more preferably 30% or greater and 45% or less.

The porosity varies depending on the compositions and contents of the silicon-based active material, negative electrode conductive material and negative electrode binder included in the negative electrode active material layer, and accordingly, the electrode has the electrical conductivity and resistance within appropriate ranges.

An exemplary embodiment of the present disclosure provides a lithium secondary battery including a positive electrode; a negative electrode for a lithium secondary battery according to aspects of the present disclosure; a separator provided between the positive electrode and the negative electrode; and an electrolyte.

The secondary battery according to the exemplary embodiment of the present disclosure may particularly include the negative electrode for a lithium secondary battery according to aspects described above. Specifically, the secondary battery may include a negative electrode, a positive electrode, a separator interposed between the positive electrode and the negative electrode, and an electrolyte, and the negative electrode is the same as the negative electrode described according to aspects above. Since the negative electrode has been described above, a detailed description thereof is omitted.

The positive electrode may include a positive electrode current collector, and a positive electrode active material layer formed on the positive electrode current collector and including the positive electrode active material.

In the positive electrode, the positive electrode current collector is not particularly limited as long as it has conductivity without causing a chemical change in the battery. For example, stainless steel, aluminum, nickel, titanium, fired carbon, aluminum or stainless steel each surface-treated with carbon, nickel, titanium, silver, or the like, or the like may be used. In addition, the positive electrode current collector may typically have a thickness of 3 to 500 μm, and a surface of the current collector may be formed with microscopic irregularities to enhance adhesive force of the positive electrode active material. For example, the positive electrode current collector may be used in various forms such as a film, a sheet, a foil, a net, a porous body, a foamed body, and a non-woven fabric body.

The positive electrode active material may be a positive electrode active material that is typically used. Specifically, the positive electrode active material may be a layered compound such as a lithium cobalt oxide (LiCoO₂) and a lithium nickel oxide (LiNiO₂), or a compound substituted with one or more transition metals; a lithium iron oxide such as LiFe₃O₄; a lithium manganese oxide such as chemical formula Li_{1+c1}Mn_{2-c1}O₄ (0≤c1≤0.33), LiMnO₃, LiMn₂O₃ and LiMnO₂; a lithium copper oxide (Li₂CuO₂); a vanadium oxide such as LiV₃O₈, V₂O₅ and Cu₂V₂O₇; Ni-site type lithium nickel oxide represented by chemical formula LiNi_{1-c2}M_{c2}O₂ (where M is at least one selected from the group consisting of Co, Mn, Al, Cu, Fe, Mg, B, and Ga, and satisfies 0.01≤c2≤0.6); a lithium manganese composite oxide represented by chemical formula LiMn_{2-c3}M_{c3}O₂ (where M is at least one selected from the group consisting of Co, Ni, Fe, Cr, Zn and Ta, and satisfies 0.01≤c3≤0.6) or Li₂Mn₃MO₈ (where M is at least one selected from the group consisting of Fe, Co, Ni, Cu and Zn); LiMn₂O₄ in which a part of Li of the chemical formula is substituted with an alkaline earth metal ion, or the like, but is not limited thereto. The positive electrode may be Li metal.

In the exemplary embodiment of the present disclosure, the positive electrode active material includes a lithium composite transition metal compound including nickel (Ni), cobalt (Co), and manganese (Mn), the lithium composite transition metal compound includes single particles or secondary particles, and an average particle diameter (D50) of the single particles may be 1 μm or greater.

For example, the average particle diameter (D50) of the single particles may be 1 μm or greater and 12 μm or less, 1 μm or greater and 8 μm or less, 1 μm or greater and 6 μm or less, greater than 1 μm and 12 μm or less, greater than 1 μm and 8 μm or less, or greater than 1 μm and 6 μm or less.

Even when the single particles are formed with a small average particle diameter (D50) of 1 μm or greater and 12 μm or less, the particle strength may be excellent. For example, the single particle may have a particle strength of 100 to 300 MPa when roll-pressing with a force of 650 kgf/cm². Accordingly, even when the single particles are roll-pressed with a strong force of 650 kgf/cm², the increase phenomenon of micro-particles in an electrode due to particle breakage is alleviated, thereby improving the lifetime characteristic of the battery.

The single particles may be manufactured by mixing and firing a transition metal precursor and a lithium source material. The secondary particles may be manufactured by a method different from that of the single particles, and the composition thereof may be the same as or different from that of the single particles.

The method of forming the single particles is not particularly limited, but generally can be formed by over-firing with raised firing temperature, or may be manufactured by using additives such as grain growth promoters that help over-firing, or by changing a starting material.

For example, the firing is performed at a temperature at which single particles can be formed. To this end, the firing should be performed at a temperature higher than a temperature during manufacturing of the secondary particles. For example, when the composition of the precursor is the same, the firing should be performed at a temperature higher than a temperature during manufacturing of the secondary particles by about 30° C. to 100° C. The firing temperature for forming the single particles may vary depending on the metal composition in the precursor. For example, when forming single particles with a high-Ni nickel-cobalt-manganese (NCM)-based lithium composite transition metal oxide having a nickel (Ni) content of 80 mol % or more, the firing temperature may be about 700° C. to 1000° C., and preferably about 800° C. to 950° C. When the firing temperature satisfies the above range, according to certain aspects, a positive electrode active material including single particles having excellent electrochemical properties can be manufactured. If the firing temperature is below 790° C., a positive electrode active material including a lithium composite transition metal compound in the form of secondary particles may be manufactured, and if the firing temperature exceeds 950° C., excessive firing occurs and a layered crystal structure may not be properly formed, so that the electrochemical properties may be deteriorated.

In the present disclosure, the phrase single particle is a term used to distinguish the same from typical secondary particles resulting from aggregation of tens to hundreds of primary particles, and is a concept including a single particle consisting of one primary particle and a quasi-single particle form that is an aggregate of 30 or less primary particles.

Specifically, in the present disclosure, the single particle may be a single particle consisting of one primary particle or a quasi-single particle form that is an aggregate of 30 or less primary particles, and the secondary particle may be an aggregate form of hundreds of primary particles.

In the exemplary embodiment of the present disclosure, the lithium composite transition metal compound, which is the positive electrode active material, further includes secondary particles, and the average particle diameter (D50) of the single particles is smaller than the average particle diameter (D50) of the secondary particles.

In the present disclosure, the single particle may be a single particle consisting of one primary particle or a quasi-single particle form that is an aggregate of 30 or less primary particles, and the secondary particle may be an aggregate form of hundreds of primary particles.

The above-described lithium composite transition metal compound may further include secondary particles. The secondary particle means a form formed by aggregation of primary particles, and can be distinguished from the concept of a single particle including one primary particle, one single particle and a quasi-single particle form, which is an aggregate of 30 or less primary particles.

The secondary particle may have a particle diameter (D50) of 1 μm to 20 μm, 2 μm to 17 μm, and preferably 3 μm to 15 μm. The specific surface area (BET) of the secondary particles may be 0.05 m²/g to 10 m²/g, preferably 0.1 m²/g to 1 m²/g, and more preferably 0.3 m²/g to 0.8 m²/g.

In a further exemplary embodiment of the present disclosure, the secondary particle is an aggregate of primary particles, and the average particle diameter (D50) of the primary particles is 0.5 μm to 3 μm. Specifically, the secondary particle may be an aggregate form of hundreds of primary particles, and the average particle diameter (D50) of the primary particles may be 0.6 μm to 2.8 μm, 0.8 μm to 2.5 μm, or 0.8 μm to 1.5 μm.

When the average particle diameter (D50) of the primary particles satisfies the above range, a single-particle positive electrode active material having excellent electrochemical properties can be formed. If the average particle diameter (D50) of the primary particles is too small, the number of aggregates of primary particles forming lithium nickel-based oxide particles increases, reducing the effect of suppressing particle breakage during roll-pressing, and if the average particle diameter (D50) of the primary particles is too large, a lithium diffusion path inside the primary particles may be lengthened, increasing a resistance and degrading an output characteristic.

According to a further exemplary embodiment of the present disclosure, the average particle diameter (D50) of the single particles is smaller than the average particle diameter (D50) of the secondary particles. As a result, the single particles may have excellent particle strength even if they are formed with a small particle diameter, and accordingly, the increase in the phenomenon of micro-particles in an electrode due to particle breakage may be alleviated, thereby improving the lifetime characteristic of the battery.

In an exemplary embodiment of the present disclosure, the average particle diameter (D50) of the single particles is smaller than the average particle diameter (D50) of the secondary particles by 1 μm to 18 μm.

For example, the average particle diameter (D50) of the single particles may be 1 μm to 16 μm smaller, 1.5 μm to 15 μm smaller, or 2 μm to 14 μm smaller than the average particle diameter (D50) of the secondary particles.

When the average particle diameter (D50) of the single particles is smaller than the average particle diameter (D50) of the secondary particles, for example, when the above range is satisfied, the single particles may have excellent particle strength even if they are formed with a small particle diameter, and as a result, the increase in the phenomenon of micro-particles in an electrode due to particle breakage may be alleviated, thereby improving the lifetime characteristic of the battery and the energy density.

According to a further exemplary embodiment of the present disclosure, the single particles are included in an amount of 15 parts by weight to 100 parts by weight based on 100 parts by weight of the positive electrode active material. The single particles may be included in an amount of 20 parts by weight to 100 parts by weight, or 30 parts by weight to 100 parts by weight based on 100 parts by weight of the positive electrode active material.

For example, the single particles may be included in an amount of 15 parts by weight or more, 20 parts by weight or more, 25 parts by weight or more, 30 parts by weight or more, 35 parts by weight or more, 40 parts by weight or more, or 45 parts by weight or more based on 100 parts by weight of the positive electrode active material. The single particles may be included in an amount of 100 parts by weight or less based on 100 parts by weight of the positive electrode active material.

According to certain aspects, when the single particles are included within the above range, excellent battery characteristics may be exhibited in combination with the negative electrode material described above. In particular, when the single particles are included in an amount of 15 parts by weight or more, the increase in the phenomenon of micro-particles in an electrode due to particle breakage in a roll-pressing process after fabrication of an electrode can be alleviated, thereby improving the lifetime characteristics of the battery.

In an exemplary embodiment of the present disclosure, the lithium composite transition metal compound may further include secondary particles, and the secondary particles may be included in an amount of 85 parts by weight or less based on 100 parts by weight of the positive electrode active material. The secondary particles may be included in an amount of 80 parts by weight or less, 75 parts by weight or less, or 70 parts by weight or less based on 100 parts by weight of the positive electrode active material. The secondary particles may be included in an amount of 0 part by weight or more based on 100 parts by weight of the positive electrode active material.

According to certain aspects, when the above range is satisfied, the above-described effects due to the existence the single particles in the positive electrode active material can be maximized. In the case in which the positive electrode active material of the secondary particles is included, the components thereof may be the same as or different from those exemplified in the single-particle positive electrode active material described above, and may mean an aggregate form of single particles.

In an exemplary embodiment of the present disclosure, the positive electrode active material in 100 parts by weight of the positive electrode active material layer may be included in an amount of 80 parts by weight or more and 99.9 parts by weight or less, preferably 90 parts by weight or more and 99.9 parts by weight or less, more preferably 95 parts by weight or more and 99.9 parts by weight or less, most preferably 98 parts by weight or more and 99.9 parts by weight or less.

The positive electrode active material layer may include a positive electrode conductive material and a positive electrode binder together with the positive electrode active material described above.

In this case, the positive electrode conductive material is used to impart conductivity to the electrode, and can be used without particular limitation as long as the positive electrode conductive material has electronic conductivity without causing a chemical change in a battery to be constituted. Specific examples may include graphite such as natural graphite and artificial graphite; a carbon-based material such as carbon black, acetylene black, Ketjen black, channel black, furnace black, lamp black, thermal black and carbon fiber; metal powders or metal fibers such as copper, nickel, aluminum and silver; a conductive whisker such as zinc oxide and potassium titanate; a conductive metal oxide such as titanium oxide; or a conductive polymer such as polyphenylene derivative, or the like, and any one thereof or a mixture of two or more thereof may be used.

In addition, the positive electrode binder serves to improve bonding between particles of the positive electrode active material and adhesion between the positive electrode active material and the positive electrode current collector. Specific examples may include polyvinylidene fluoride (PVDF), vinylidene fluoride-hexafluoropropylene copolymer (PVDF-co-HFP), polyvinyl alcohol, polyacrylonitrile, carboxymethylcellulose (CMC), starch, hydroxypropylcellulose, regenerated cellulose, polyvinylpyrrolidone, polytetrafluoroethylene, polyethylene, polypropylene, ethylene-propylene-diene polymer (EPDM), sulfonated-EPDM, styrene butadiene rubber (SBR), fluoro rubber, or various copolymers thereof, and the like, and any one thereof or a mixture of two or more thereof may be used.

The separator serves to separate the negative electrode and the positive electrode and to provide a movement path of lithium ions, in which any separator may be used as the separator without particular limitation as long as it is typically used in a secondary battery, and particularly, a separator having high moisture-retention ability for an electrolyte solution as well as a low resistance to the movement of electrolyte ions may be preferably used. Specifically, a porous polymer film, for example, a porous polymer film manufactured from a polyolefin-based polymer, such as an ethylene homopolymer, a propylene homopolymer, an ethylene/butene copolymer, an ethylene/hexene copolymer, and an ethylene/methacrylate copolymer, or a laminated structure having two or more layers thereof may be used. In addition, a typical porous non-woven fabric, for example, a non-woven fabric formed of high melting point glass fibers, polyethylene terephthalate fibers, or the like may be used. Furthermore, a coated separator including a ceramic component or a polymer material may be used to secure heat resistance or mechanical strength, and the separator having a single layer or multilayer structure may be selectively used.

In particular, by providing the ceramic layer on top of the silicon-based negative active material layer according to aspects of the present disclosure, a ceramic layer formed on the separator can be eliminated or minimized, allowing a material thickness of the separator to be reduced, resulting in excellent features in terms of process and cost.

Examples of the electrolyte may include an organic liquid electrolyte, an inorganic liquid electrolyte, a solid polymer electrolyte, a gel-type polymer electrolyte, a solid inorganic electrolyte, or a molten-type inorganic electrolyte that may be used in the manufacturing of the lithium secondary battery, but are not limited thereto.

Specifically, the electrolyte may include a non-aqueous organic solvent and a metal salt.

As the non-aqueous organic solvent, for example, an aprotic organic solvent such as N-methyl-2-pyrrolidinone, propylene carbonate, ethylene carbonate, butylene carbonate, dimethyl carbonate, diethyl carbonate, gamma-butyrolactone, 1,2-dimethoxy ethane, tetrahydrofuran, 2-methyltetrahydrofuran, dimethyl sulfoxide, 1,3-dioxolane, formamide, dimethylformamide, dioxolane, acetonitrile, nitromethane, methyl formate, methyl acetate, phosphoric acid triester, trimethoxy methane, dioxolane derivative, sulfolane, methyl sulfolane, 1,3-dimethyl-2-imidazolidinone, propylene carbonate derivative, tetrahydrofuran derivative, ether, methyl propionate, or ethyl propionate may be used.

In particular, among the carbonate-based organic solvents, ethylene carbonate and propylene carbonate, which are cyclic carbonates, are high-viscosity organic solvents and can be preferably used because they have high permittivity to dissociate a lithium salt well. When the cyclic carbonate is mixed with a linear carbonate with low viscosity and low permittivity, such as dimethyl carbonate or diethyl carbonate, in a suitable ratio and used, an electrolyte having high electric conductivity may be prepared, and therefore, may be more preferably used.

A lithium salt may be used as the metal salt, and the lithium salt is a material that is readily soluble in the non-aqueous electrolyte solution, in which, for example, one or more species selected from the group consisting of F⁻, Cl⁻, I⁻, NO₃⁻, N(CN)₂⁻, BF₄⁻, ClO₄⁻, PF₆⁻, (CF₃)₂PF₄⁻, (CF₃)₃PF₃, (CF₃)₄PF₂, (CF₃)₅PF, (CF₃)₆ P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻ and (CF₃CF₂SO₂)₂N⁻may be used as an anion of the lithium salt.

One or more additives, for example, a haloalkylene carbonate-based compound such as difluoroethylene carbonate, pyridine, triethylphosphite, triethanolamine, cyclic ether, ethylenediamine, n-glyme, hexaphosphoric triamide, a nitrobenzene derivative, sulfur, a quinone imine dye, N-substituted oxazolidinone, N, N-substituted imidazolidine, ethylene glycol dialkyl ether, an ammonium salt, pyrrole, 2-methoxy ethanol, or aluminum trichloride, may be further included in the electrolyte for the purpose of improving life characteristics of the battery, suppressing a decrease in battery capacity, improving discharge capacity of the battery, and the like, in addition to the above-described electrolyte components.

An exemplary embodiment of the present disclosure provides a battery module including the secondary battery as a unit cell, and a battery pack including the same.

Since the battery module and the battery pack include the secondary battery having high capacity, high-rate capability, and high cycle characteristics, the battery module and the battery pack may be used as a power source of a medium to large sized device selected from the group consisting of an electric vehicle, a hybrid electric vehicle, a plug-in hybrid electric vehicle, and a power storage system.

Hereinafter, preferred examples will be provided for better understanding of the present disclosure. It will be apparent to one skilled in the art that the examples are only provided to illustrate the present disclosure and various modifications and alterations are possible within the scope and technical spirit of the present disclosure. Such modifications and alterations naturally fall within the scope of claims included herein.

### EXAMPLES

### Preparation of Negative Electrode

### Example 1: Preparation of Negative Electrode

### Preparation of Negative Electrode Active Material Layer

A negative electrode active material layer composition was prepared using Si (average particle diameter (D50): 5 μm) as a silicon-based active material, a first conductive material, a second conductive material, and polyacrylamide as a binder at a weight ratio of 80:9.6:0.4:10. A negative electrode slurry was manufactured by adding the composition to distilled water as a solvent for forming a negative electrode slurry (solid concentration: 28 wt %).

The first conductive material was plate-like graphite (specific surface area: 17 m²/g, average particle diameter (D50): 3.5 μm), and the second conductive material was carbon nanotubes.

As a mixing method, the first conductive material, the second conductive material, the binder and water were dispersed at 2500 rpm for 30 minutes by using a homo mixer, the active material was added thereto, and the resultant mixture was dispersed at 2500 rpm for 30 minutes to fabricate a slurry.

The negative electrode slurry was coated on both surfaces of a copper current collector (thickness: 15 μm) serving as a negative electrode current collector with a loading amount of 3.00 mg/cm², which was then roll-pressed and dried in a vacuum oven at 130° C. for 10 hours to form a negative electrode active material layer (thickness: 23 μm).

### Preparation of Ceramic Layer

A ceramic layer composition with BaTiO₃:Al₂O₃ as ceramic mixed at parts by weight of 20:80 on the basis of 100 parts by weight of ceramic and PVdF as a binder included in an amount of 20 parts by weight on the basis of 100 parts by weight of the ceramic layer composition was prepared. Then, it was added to acetone as a solvent to fabricate a ceramic layer composition. (solid concentration: 18% by weight)

Then, the ceramic layer composition was coated on top of the negative electrode active material layer, which was then roll-pressed and dried in a vacuum oven at 60° C. for 10 hours to form a ceramic layer (thickness: 4 μm).

A negative electrode was prepared in the same manner as in Example 1 except that, in Example 1, preparation conditions of the negative electrode active material layer and the ceramic layer were changed as described below.

TABLE 1

| | Ceramic layer | | | |
|---|---|---|---|---|
| | | binder | | |
| | ceramic | (part | thick- | Negative electrode |
| | (weight | by | ness | active material layer |
| | ratio) | weight) | (μm) | composition |
| Example 1 | BaTiO₃:Al₂O₃ = | PVdF | 4 | Same as Example 1 |
| | 20:80 | (20) | | |
| Example 2 | BaTiO₃:Al₂O₃ = | PVdF | 4 | Same as Example 1 |
| | 35:65 | (20) | | |
| Example 3 | BaTiO₃:Al₂O₃ = | PVdF | 6 | Same as Example 1 |
| | 20:80 | (20) | | |
| Example 4 | BaTiO₃:Al₂O₃ = | PVdF | 2 | Same as Example 1 |
| | 20:80 | (20) | | |
| Example 5 | BaTiO₃:Al₂O₃ = | PVdF | 4 | Si (average particle |
| | 20:80 | (20) | | diameter (D50): 5 μm) |
| | | | | as silicon-based |
| | | | | active material, first |
| | | | | conductive material, |
| | | | | second conductive |
| | | | | material and |
| | | | | polyacrylamide as |
| | | | | binder = 85:7.6:0.4:7 |
| Example 6 | BaTiO₃:Al₂O₃ = | PVdF | 4 | Si (average particle |
| | 20:80 | (20) | | diameter (D50): 5 μm) |
| | | | | as silicon-based |
| | | | | active material, first |
| | | | | conductive material, |
| | | | | second conductive |
| | | | | material and |
| | | | | polyacrylamide as |
| | | | | binder = 87:5.8:0.2:7 |
| Example 7 | BaTiO₃:Al₂O₃ = | PVdF | 4 | Si (average particle |
| | 30:70 | (20) | | diameter (D50): 5 μm) |
| | | | | as silicon-based |
| | | | | active material, first |
| | | | | conductive material, |
| | | | | second conductive |
| | | | | material and |
| | | | | polyacrylamide as |
| | | | | binder = 85:7.6:0.4:7 |
| Example 8 | BaTiO₃:Al₂O₃ = | PVdF | 4 | Si (average particle |
| | 30:70 | (20) | | diameter (D50): 5 μm) |
| | | | | as silicon-based |
| | | | | active material, first |
| | | | | conductive material, |
| | | | | second conductive |
| | | | | material and |
| | | | | polyacrylamide as |
| | | | | binder = 87:5.8:0.2:7 |
| Comparative | BaTiO₃:Al₂O₃ = | PVdF | 4 | Same as Example 1 |
| Example 1 | 55:45 | (20) | | |
| Comparative | BaTiO₃:Al₂O₃ = | PVdF | 4 | Same as Example 1 |
| Example 2 | 5:95 | (20) | | |
| Comparative | BaTiO₃ | PVdF | 4 | Same as Example 1 |
| Example 3 | | (20) | | |
| Comparative | Al₂O₃ | PVdF | 4 | Same as Example 1 |
| Example 4 | | (20) | | |
| Comparative | BaTiO₃:Al₂O₃ = | PVdF | 10.5 | Same as Example 1 |
| Example 5 | 55:45 | (20) | | |
| Comparative | BaTiO₃:Al₂O₃ = | PVdF | 0.4 | Same as Example 1 |
| Example 6 | 55:45 | (20) | | |
| Comparative | BaTiO₃:Al₂O₃ = | PVdF | 4 | Si (average particle |
| Example 7 | 8:82 | (20) | | diameter (D50): 5 μm) |
| | | | | as silicon-based |
| | | | | active material, first |
| | | | | conductive material, |
| | | | | second conductive |
| | | | | material and |
| | | | | polyacrylamide as |
| | | | | binder = 87:5.8:0.2:7 |
| Comparative | BaTiO₃:Al₂O₃ = | PVdF | 4 | Same as Example 1 |
| Example 8 | 8:82 | (20) | | |
| Comparative | Al₂O₃ = 100 | PVdF | 4 | Si (average particle |
| Example 9 | | (20) | | diameter (D50): 5 μm) |
| | | | | as silicon-based |
| | | | | active material, first |
| | | | | conductive material, |
| | | | | second conductive |
| | | | | material and |
| | | | | polyacrylamide as |
| | | | | binder = |
| | | | | 65:14.6:0.4:20 |

### Manufacture of Secondary Battery

A positive electrode slurry was prepared by adding LiNi_{0.6}Co_{0.2}Mn_{0.2}O₂ (average particle diameter (D50): 15 μm) as a positive electrode active material, carbon black (product name: Super C65, manufacturer: Timcal) as a conductive material, and polyvinylidene fluoride (PVdF) as a binder to N-methyl-2-pyrrolidone (NMP) as a solvent for formation of a positive electrode slurry in a weight ratio of 97:1.5:1.5 (solid concentration: 78 wt %).

The positive electrode slurry was coated on both surfaces of an aluminum current collector (thickness: 12 μm) serving as a positive electrode current collector with a loading amount of 537 mg/25 cm², which was then roll-pressed and dried in a vacuum oven at 130° C. for 10 hours to form a positive electrode active material layer (thickness: 65 μm), whereby a positive electrode was manufactured (thickness of the positive electrode: 77 μm, porosity: 26%).

A secondary battery of Example 1 was manufactured by interposing a polyethylene separator between the positive electrode and the negative electrode of Example 1 and injecting an electrolyte.

The electrolyte was obtained by adding vinylene carbonate to an organic solvent, in which fluoroethylene carbonate (FEC) and diethyl carbonate (DEC) were mixed in a volume ratio of 30:70, in an amount of 3 wt. % on the basis of a total weight of the electrolyte and adding LiPF₆ as a lithium salt to a concentration of 1M.

Secondary batteries were prepared in the same manner as described above, respectively, except that the negative electrodes of Examples 2 to 4 and Comparative Examples 1 to 6 were used.

### Experimental Example 1: Evaluation of Monocell Life

For the secondary batteries prepared above, the life and the capacity retention rate were evaluated using an electrochemical charging and discharging device. This evaluation was conducted at high temperature and was intended to be evaluated in connection with a gas generation experiment in Experimental Example 2, which will be described below. The secondary batteries were subjected to 100 cycles under conditions of charging (1.00 CC/CV charging, 4.2 V, 0.05 C Cut) and discharging (0.50 CC discharging, 3.0V Cut) at 45° C. and then the capacity retention rates thereof were confirmed.

The 100th capacity retention rate was evaluated using the formula below, and the results are shown in Table 2 below.

$$capacity retention rate ( \% ) = \{ ( discharge capacity at 100 th cycle ) / ( discharge capacity at first cycle ) \} \times 100$$

TABLE 2

| | Capacity retention |
|---|---|
| | rate @ 100 cycle number |
| Example 1 | 92.5 |
| Example 2 | 91.7 |
| Example 3 | 91.2 |
| Example 4 | 93.7 |
| Example 5 | 88.5 |
| Example 6 | 86.1 |
| Example 7 | 89.9 |
| Example 8 | 87.4 |
| Comparative Example 1 | 83.1 |
| Comparative Example 2 | 76.9 |
| Comparative Example 3 | 77.4 |
| Comparative Example 4 | 72.7 |
| Comparative Example 5 | 76.8 |
| Comparative Example 6 | 78.2 |
| Comparative Example 7 | 73.1 |
| Comparative Example 8 | 75.5 |
| Comparative Example 9 | 78.4 |

Life evaluation is usually conducted at room temperature, 25° C. However, since gas is significantly generated by a side reaction only after a long life elapses, life evaluation was conducted at high temperatures where more gases are generated. At high temperatures, a significant difference could be confirmed because more reactions to form SEI layers occurred along with gas generation by the side reaction, and this corresponded to an evaluation that made it easier to check the effect on ceramic particles.

In the result of the life evaluation in Table 2, it could be confirmed that the performance of the Examples was superior to that of the Comparative examples. Among the Examples, Example 1 in which BaTiO₃ with small particles and Al₂O₃ with relatively large particles were provided in the optimal ratio showed the best performance, and it could be confirmed in Example 4 that if the ceramic composition was the same and the thickness was thin, the resistance according to the thickness of the separator ceramic layer decreased and some performance increased.

In addition, Examples 5 to 8 each correspond to a case in which the content of silicon was increased, and accordingly, the ratio of BaTiO₃ was also increased. That is, in Examples 5 to 8, it can be confirmed that as the content of the silicon-based active material increases, the amounts of conductive material and binder decrease, resulting in some decrease in performance, as compared with Examples 1 to 4, but it could be confirmed that the capacity retention rate is very excellent, as compared with the Comparative Examples.

In Comparative Example 1, the proportion of BaTiO₃ was high, so the gas might be effectively removed. However, since the particles are small, the packing density of the ceramic layer was increased and the migration of ions was blocked, resulting in lower ionic conductivity and lower life performance.

In Comparative Example 2, the proportion of BaTiO₃ was relatively low, so the resistance of the separator was low. However, gas generation could not be effectively suppressed, and a local gas trap was generated between the electrode and the separator, resulting in lower life performance.

In Comparative Example 3, BaTiO₃ alone was provided, and the resistance of the battery was evaluated as being high due to the same effect as in Comparative Example 1. In Comparative Example 4, like Comparative Example 2, there was no major problems with resistance, but gas generation could not be suppressed.

In Comparative Examples 5 and 6, the composition was the same as in Comparative Example 1, but the thickness was larger or smaller. It is determined that if the thickness is large, as in Comparative Example 5, performance deteriorates due to increased resistance, and if the thickness is very thin, as in Comparative Example 6, the absolute amount of BaTiO₃ is very small, and therefore, a similar trend to Comparative Example 2, where the content of BaTiO₃ is very low, is exhibited.

Experimental Example 2: Gas Analysis Result (after 100-cycle life of monocell)

Analysis was conducted to check the gas generation state after the 100-cycle life of the previously evaluated monocell. Gas analysis was performed qualitatively using GC/MS equipment, and 11 types of gases (H₂, CO, CO₂, CH₄, C₂H₂, C₂H₄, C₂H₆, C₃H₆, C₃H₈, O₂, N₂), which produce the most gas through a reaction with an electrolyte solution, were analyzed, and results are shown in Table 3 below.

TABLE 3

| | Total amount of gas (total |
|---|---|
| | amount of 11 types of gases) |
| Example 1 | 65.4 |
| Example 2 | 58.7 |
| Example 3 | 60.1 |
| Example 4 | 86.8 |
| Example 5 | 93.4 |
| Example 6 | 97.5 |
| Example 7 | 52.4 |
| Example 8 | 56.1 |
| Comparative Example 1 | 58.2 |
| Comparative Example 2 | 241.9 |
| Comparative Example 3 | 55.9 |
| Comparative Example 4 | 589.0 |
| Comparative Example 5 | 55.5 |
| Comparative Example 6 | 250.4 |
| Comparative Example 7 | 427.1 |
| Comparative Example 8 | 314.8 |
| Comparative Example 9 | 578.5 |

As a result of the gas analysis, it could be confirmed that the amount of gas generation was small in the Examples in which the content of BaTiO₃ was appropriate and the thickness was appropriate. In addition, it could be confirmed that the amount of gas generation was smaller in Example 2 in which the content of BaTiO₃ was high and in Example 3 in which the thickness of the ceramic layer was large, so the composition was small but the quantitative amount of BaTiO₃ was large, as compared with Example 1. In Example 4 in which the thickness was relatively thin and the composition of BaTiO₃ was 20, the amount of gas generation was larger, as compared with Examples 1 to 3.

Most of the Comparative Examples showed the larger amount of gas generation, as compared with the Examples, which is a result of the quantitative amount of BaTiO₃. Comparative Example 1, Comparative Example 3, and Comparative Example 5 correspond to cases where the composition content of BaTiO₃ is high or is a single composition, or the absolute amount thereof is high due to the large thickness, and in this case, the total amount of gas generation similar to the Examples is shown.

However, in Comparative Examples 2, 4 and 6 in which the composition content of Al₂O₃ is high or is a single composition, or the amount of BaTio₃ is small due to the small thickness, it could be confirmed that the amount of gas generation was large, and it was determined to affect the life performance.

That is, as can be seen from Tables 2 and 3, the battery using the negative electrode according to the present disclosure is excellent in life retention rate, and at the same time, has performance improved by suppressing gas generation.

1. A negative electrode for a lithium secondary battery comprising:
a negative electrode current collector layer;
a silicon-based negative electrode active material layer provided on at least one surface of the negative electrode current collector layer; and
a ceramic layer provided on a surface of the silicon-based negative electrode active material layer opposite to a surface of the negative electrode active material layer facing the negative electrode current collector layer,
wherein the ceramic layer comprises a ceramic layer composition or a dried product thereof,
wherein a thickness of the ceramic layer is 0.5 μm or greater and 10 μm or less,
wherein the ceramic layer composition comprises ceramic and a binder, and
wherein BaTiO₃ is included in an amount of 10 parts by weight or more and 50 parts by weight or less based on 100 parts by weight of the ceramic.

2. The negative electrode for the lithium secondary battery of claim 1, wherein the ceramic further comprises one or more selected from the group consisting of Al₂O₃, ZrO₂, SiO₂, TiO₂, ZnO, SrTiO₃, CaCO₃, CaO, CeO₂, NiO, MgO, SnO₂, Y₂O₃, Pb(Zr,Ti)O₃(PZT), (Pb,La)(Zr,Ti) O₃(PLZT), Pb(Mg_{1/3}Nb_{2/3})O₃-PbTiO₃(PMN-PT) and hafnia (HfO₂).

3. The negative electrode for the lithium secondary battery of claim 1, wherein the binder is polyvinylidene fluoride (PVdF) or polyvinylidene fluoride-hexafluoropropylene (PVdF-HFP).

4. The negative electrode for the lithium secondary battery of claim 1, wherein the ceramic is included in an amount of 60 parts by weight or more and 95 parts by weight or less and the binder is included in an amount of 5 parts by weight or more and 40 parts by weight or less based on 100 parts by weight of the ceramic layer composition.

5. The negative electrode for the lithium secondary battery of claim 1, wherein an adhesive strength is 10 gf/15 mm or higher and 100 gf/15 mm or less for bonding of a lithium metal layer to a surface of the ceramic layer opposite to a surface of the ceramic layer facing the silicon-based negative electrode active material layer and then allowing to stand at 23° C. for 10 seconds to 2 minutes.

6. The negative electrode for the lithium secondary battery of claim 1, wherein the silicon-based negative electrode active material layer comprises a negative electrode active material layer composition, and
wherein the negative electrode active material layer composition comprises one or more selected from the group consisting of a silicon-based active material, a negative electrode conductive material, and a negative electrode binder.

7. The negative electrode for the lithium secondary battery of claim 6, wherein the negative electrode active material layer composition comprises silicon-based active material that comprises one or more selected from the group consisting of SiOx (x=0) and SiOx (0<x≤2).

8. The negative electrode for the lithium secondary battery of claim 6, wherein the negative electrode active material layer composition comprises the negative electrode conductive material, and wherein the negative electrode conductive material comprises a planar conductive material and a linear conductive material, and
wherein the planar conductive material is included in an amount of 80 parts by weight or more and 99.9 parts by weight or less based on 100 parts by weight of the negative electrode conductive material.

9. The negative electrode for the lithium secondary battery of claim 6, wherein the negative electrode active material layer composition comprises the silicon-based active material, and wherein the silicon-based active material is included in an amount of 70 parts by weight or more based on 100 parts by weight of the negative electrode active material layer composition.

10. A method for manufacturing a negative electrode for a lithium secondary battery, the method comprising:
preparing a negative electrode current collector layer;
forming a negative electrode active material layer by applying a negative electrode active material layer composition on at least one surface of the negative electrode current collector layer; and
forming a ceramic layer by applying a ceramic layer composition on a surface of the negative electrode active material layer opposite to a surface of the negative electrode active material layer facing the negative electrode current collector layer,
wherein a thickness of the ceramic layer is 0.5 μm or greater and 10 μm or less,
wherein the ceramic layer composition comprises ceramic and a binder, and
wherein BaTiO₃ is included in an amount of 10 parts by weight or more and 50 parts by weight or less based on 100 parts by weight of the ceramic.

11. The method of claim 11, comprising drying a solvent in the ceramic layer composition through drying and rolling after applying the ceramic layer composition.

12. The method of claim 11, comprising pre-lithiating the negative electrode having the negative electrode active material layer and ceramic layer formed on the negative electrode current collector layer,
wherein the pre-lithiating of the negative electrode comprises a lithium electroplating process, a lithium metal transfer process, a lithium metal deposition process, or a stabilized lithium metal powder (SLMP) coating process.

13. A lithium secondary battery comprising:
a positive electrode;
the negative electrode for a lithium secondary battery of claim 1;
a separator provided between the positive electrode and the negative electrode; and
an electrolyte.

14. The negative electrode for the lithium secondary battery of claim 6, wherein the negative electrode active material layer composition comprises silicon-based active material that comprises 70 parts by weight or more of the SiOx (x=0) based on 100 parts by weight of the silicon-based active material.
